(19) United States
(12) Patent Application Publication
(10) Pub. No.: US 2007/0155932 A1
(43) Pub. Date: Jul. 5, 2007

(54) Method for the production of substances comprising carbodimide groups

(75) Inventors: Emmanouil Spyrou, Schermbeck (DE); Bernhard Eikemper, Bottrop (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/586,370

(22) PCT Filed: Jan. 13, 2005
(86) PCT No.: PCT/EP05/50119

§ 371 Date: Jul. 18, 2006

(30) Foreign Application Priority Data
Mar. 9, 2004 (DE) 10 2004 011 791.8

(51) Int. Cl. C08G 18/00

(52) U.S. Cl. 528/44

(57) ABSTRACT

The invention relates to a process for preparing substances bearing carbodiimide groups.

The invention relates to a process for preparing substances bearing carbodiimide groups.

Substances bearing carbodiimide groups are very useful as crosslinkers for polymers bearing carboxylic acid groups. One of their uses is therefore for the crosslinking of carboxyl-containing latices (U.S. Pat. No. 4,419,294, U.S. Pat. No. 482,063). They also find use as moisture scavengers in reactive systems.

The preparation of carbodiimide groups from isocyanates is known and has been described, for example, in U.S. Pat. No. 2,840,589 and U.S. Pat. No. 2,941,966. Nowadays, it is common to all widely used processes that the catalysts used are compounds of phosphorus, for example 1-methylphospholene 1-oxide. Such phosphorus compounds are toxic and frequently also carcinogenic. The preparation and also the use of such toxic phosphorus compounds constitutes an occupational hygiene problem.

It is therefore an object of the invention to prepare substances containing carbodiimide groups from isocyanates without having to resort to poisonous or carcinogenic catalysts.

Surprisingly, this object is achieved by a process using water and/or water-containing or -releasing substances, and/or amines and/or ureas as catalysts.

The present invention provides a process for preparing substances bearing carbodiimide from isocyanates using water and/or water-containing or -releasing substances, and/or amines and/or ureas as catalysts.

The present invention preferably provides a process for preparing substances bearing carbodiimide from isocyanates obtained by reacting a mixture of
A) at least one starting compound having at least one isocyanate group,
B) at least one catalyst in an amount of from 0.01 to 30% by weight, based on the sum of A) and B), selected from
   1. water,
   2. water-containing and/or water-releasing substances,
   3. primary and/or secondary amines,
   4. ureas having the structure R¹—NH—CO—NR³R³, where R¹, R² and R³ are each identical or different radicals having from 1 to 15 carbon atoms or H,
C) optionally one or more cocatalysts from the group of metal-containing substances in an amount of from 0.00001 to 1% by weight, based on the sum of A) and B),
   by holding the mixture of A), B) and, where present, C) at a temperature of from 120 to 300° C. and at pressures between 1 and 25 bar for from 5 minutes to 12 hours.

According to the invention, the component A) used may comprise any substances bearing isocyanate, for example cyclohexyl isocyanate, isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), diisocyanato-methylbenzene, especially the 2,4- and the 2,6-isomers, and technical grade mixtures of both isomers (TDI), tetramethylxylylene diisocyanate (TMXDI) and dicyclohexylmethyl diisocyanate (H12MDI). Preference is given to using IPDI, HDI and H12MDI. Also suitable are derivatives of the aforementioned isocyanates, for example isocyanurates, uretidiones, allophanates and/or biurets.

Useful catalysts B) are all substances which either contain water or release water during the reaction.

Useful catalysts are, for B1), water and, for B2), water-containing and water-releasing substances, for example inorganic compounds having water of crystallization, molecular sieves, ion exchangers, hydrous polymer gels, for example superabsorbents.

Suitable catalysts B3) are primary or secondary amines, for example cyclohexylamine, methylamine, ethylamine, butylamine, dimethylamine, diethylamine, dibutylamine. Particular preference is given to secondary amines, for example cyclohexylamine.

The ureas B4) used can be all compounds having the structure R¹—NH—CO—NR²R³, where R¹, R² and R³ are each identical or different radicals having from 1 to 15 carbon atoms or H. In particular, the R¹ to R³ radicals may simultaneously or each independently be methyl, ethyl, propyl, butyl, pentyl, hexyl, cyclohexyl, and the homologous series can be continued up to alkyl radicals having 15 carbon atoms. It is also possible to use ureas having aromatic radicals. Particular preference is given to dicyclohexylurea.

Particularly suitable water-containing substances are, for example, molecular sieves. In a chemical sense, molecular sieves are zeolites. According to Römpps Chemie Lexikon (Thieme Verlag, Stuttgart, 1999), zeolites is a “derived expression for a wide-ranging group of crystalline silicates, specifically of hydrous alkali metal or alkaline earth metal aluminosilicates (similar to the feldspars) of the general formula M₂/_{z}O.Al₂O₃.xSiO₂.yH₂O where M=monovalent or polyvalent metal (usually an alkali metal or alkaline earth metal cation), H or NH₄, inter alia, z=valency of the cation, x=from 1.8 to approx. 12 and y=0 to approx. 8. The stoichiometric ratio of SiO₂ to Al₂O₃ (modulus) is an important parameter of the zeolites. It is characteristic of most zeolites that they release their water continuously in the course of heating and without change in the crystal structure, and take up other compounds in place of the water removed. Zeolites may be obtained in the chemical trade (for example Aldrich) under the description of molecular sieves.

Suitable cocatalysts C) are metal-containing substances, in particular those based on tin, zinc and bismuth, for example tin(II) chloride, dibutyltin dilaurate, zinc octoate, zinc acetylacetonate and bismuth neododecanoate. Particular preference is given to tin(II) chloride. Such cocatalysts are used in amounts of from 0.00001 to 1%.

The process proceeds in such a way that initially all components A), B) and, where present, C) are mixed together at room temperature. In the case of solid isocyanates, a mixing temperature above the melting point is selected. The mixture is then brought to a temperature between 120 and 300° C. and held at this temperature for from 5 minutes to 12 hours. Preference is given to temperatures between 200 and 250° C. and reaction times between 1 and 6 hours. If appropriate, this reaction may also be carried out in a pressure vessel at pressures between 1 and 25 bar. On completion of reaction, unconverted component A) may optionally be removed by suitable separation processes. Useful processes in this context are distillative processes, in particular short-path and thin-film distillations.

The invention is illustrated in detail hereinbelow by experimental examples, without restricting it thereto.

### EXAMPLES

The starting materials used are the following components:

| Starting materials | Manufacturer |
|---|---|
| Cyclohexyl isocyanate | Aldrich |
| Cyclohexylamine | Aldrich |
| Dicyclohexylamineurea | Aldrich |
| Molecular sieve (0.5 nm) | Merck, 2 mm bead form |
| Tin(II) chloride | Aldrich |
| Dicyclohexylcarbodiimide | Aldrich |

General Experimental Procedure

The starting materials are mixed at room temperature and then kept at 230° C. for 4 hours in an autoclave. Afterward, the reaction mixture is cooled to room temperature and investigated with the aid of gas chromatography.

Data in % by weight

| | 1 | 2 | 3 | 4 | 5 | C1* | C2* |
|---|---|---|---|---|---|---|---|
| Cyclohexyl isocyanate | 99.9 | 99.7 | 99.5 | 95.0 | 99.9 | 100 | 100 |
| Water | 0.1 | | | | 0.1 | | |
| Cyclohexylamine | | 0.3 | | | | | |
| Dicyclohexylamineurea | | | 0.5 | | | | |
| Molecular sieve (0.5 nm) | | | | 5.0 | | | |
| Tin(II) chloride | | | | | 0.004 | | 0.004 |
| Analysis of the reaction product: | 15.9 | 9.6 | 8.9 | 30.8 | 21.5 | 3.4 | 4.3 |
| Dicyclohexylcarbodiimide | | | | | | | |
| (GC, area %) | | | | | | | |

*These are noninventive, comparative examples.

1. A process for preparing substances bearing carbodiimide from isocyanates using water and/or water-containing or -releasing substances, and/or amines and/or ureas as catalysts.

2. A process for preparing substances bearing carbodiimide from isocyanates obtained by reacting a mixture of
A) at least one starting compound having at least one isocyanate group,
B) at least one catalyst in an amount of from 0.01 to 30% by weight, based on the sum of A) and B), selected from
1. water,
2. water-containing and/or water-releasing substances,
3. primary and/or secondary amines,
4. ureas having the structure R¹—NH—CO—NR³R³, where R¹, R² and R³ are each identical or different radicals having from 1 to 15 carbon atoms or H,
C) optionally one or more cocatalysts from the group of metal-containing substances in an amount of from 0.00001 to 1% by weight, based on the sum of A) and B), by holding the mixture of A), B) and, where present, C) at a temperature of from 120 t300° C. and at pressures between 1 and 25 bar for from 5 minutes to 12 hours.

3. The process of claim 1,
wherein
the component A) used is cyclohexyl isocyanate, isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), diisocyanato-methylbenzene, especially the 2,4- and the 2,6-isomers, and technical grade mixtures of both isomers (TDI), tetramethylxylylene diisocyanate (TMXDI) and dicyclohexylmethyl diisocyanate (H12MDI).

4. The process of claim 3,
wherein
IPDI, HDI and/or H12MDI are used.

5. The process of claim 1,
wherein
the isocyanates used are isocyanurates, uretidiones, allophanates and/or biurets.

6. The process of claim 1,
wherein
the component B2) used comprises inorganic compounds having water of crystallization, molecular sieves, ion exchangers, hydrous polymer gels, for example superabsorbents.

7. The process of claim 1,
wherein
the amines B3) used are cyclohexylamine, methylamine, ethylamine, butylamine, dimethylamine, diethylamine, dibutylamine.

8. The process of claim 1,
wherein
the urea B4) used is dicyclohexylurea.

9. The process of claim 1,
wherein
cocatalysts C) based on tin, zinc and/or bismuth are used.

10. The process of claim 9,
wherein
tin(II) chloride, dibutyltin dilaurate, zinc octoate, zinc acetylacetonate and bismuth neododecanoate are used alone or in mixtures.
